(19) United States
(12) Patent Application Publication
(10) Pub. No.: US 2026/0289023 A1
(43) Pub. Date: Sep. 24, 2026

(54) SYSTEM AND METHOD FOR DETECTING AND PREVENTING UNAUTHORIZED SCREEN PHOTOGRAPHY

(71) Applicants: Eliad AVNI, Caesarea (IL); Yedidia Yitzhak SCHOLLSSBERG, Tel Aviv-Yafo (IL)

(72) Inventor: Eliad AVNI, Caesarea (IL)

(73) Assignees: Eliad AVNI, Caesarea (IL); Yedidia Yitzhak SCHOLLSSBERG, Tel Aviv-Yafo (IL)

(21) Appl. No.: 19/565,643

(22) Filed: Mar. 13, 2026

(30) Foreign Application Priority Data
Mar. 19, 2025 (IL) 319717

(51) Int. Cl. G06F 21/84; G06F 21/60

(52) U.S. Cl. CPC G06F 21/84; G06F 21/604

(57) ABSTRACT

A computer security system and method for detecting and preventing unauthorized photographing of information displayed on computer screens, utilizing sensors associated with a computer terminal, such as a camera, to capture visual sensor data including visual sensor data representing an area located in front of or around the screen. A detection module analyzes captured sensor data, including visual sensor data, to identify photographing activity based on visual detection of imaging devices, photographing posture of a user, visual characteristics of an optical imaging component, and behavioral patterns consistent with image capture. Upon detection of photographing activity, capturing screen content, or capturing visual evidence of the individual performing the activity, storing forensic evidence in a database, and initiating protective screen modifications. The protective mechanisms may include display transformations such as screen blurring, pixel modulation, brightness interference, flicker patterns, watermarking, or masking of displayed content in order to prevent or degrade photographic capture.

### CROSS-REFERENCE TO RELATED APPLICATIONS

This application claims the benefit of priority from Israel Patent Application No. 319717, filed Mar. 19, 2025, the disclosure of which is incorporated herein by reference.

### TECHNICAL FIELD

The invention relates to the field of computer security systems.

More particularly, the invention relates to systems and methods for detecting unauthorized photographing of sensitive information displayed on computer terminals, including attempts performed by insiders within a physical workspace.

The invention further relates to systems that automatically generate forensic evidence associated with such attempts, including capture of the displayed content and capture of identity evidence of the individual performing the activity, for subsequent investigation and enforcement.

The invention further relates to techniques for preventing photographic capture of information displayed on computer screens.

### BACKGROUND

FIG. 1 depicts the problem to be solved. In many organizations, sensitive information is displayed on screens 12 of computer terminals 52A, including but not limited to financial records, customer information, trade secrets, source code, medical records, and other confidential data.

A person 50A may be an employee or other insider with legitimate access to computer terminal 52A. Person 50A may attempt to capture the displayed content using a personal camera device 14, such as a smartphone, wearable camera, miniature camera, or any other image capture device.

In such scenarios, the photographing attempt can occur without interacting with the operating system or applications of the computer terminal, thereby bypassing conventional software controls such as screenshot restrictions or screen-sharing policies.

Conventional security approaches may rely on specialized environmental sensors, infrared (IR) emitters/receivers, or hardware detectors. Such approaches may be expensive to deploy at scale, may require dedicated installation, and may be unreliable in real-world office environments due to lighting conditions, occlusions, or device variability.

In addition, many existing approaches focus on generating a basic alert and do not provide strong attribution of the actor or a consolidated forensic evidence package that can be reviewed by security personnel.

There is therefore a need for an improved system capable of detecting photographing attempts performed in a physical workspace, and of automatically capturing reliable forensic evidence associated with the attempt, including both the leaked screen content and the identity evidence of the individual performing the photographing activity.

### SUMMARY OF THE INVENTION

According to one aspect, the invention provides a photographing security system 10 for detecting unauthorized photographing of information displayed on screens 12 associated with computer terminals 52A.

In one embodiment, the system includes: (i) a sensor 20 associated with the computer terminal, the sensor comprising a camera or other visual sensing device configured to capture sensor data including visual sensor data from an area located in front of or around the screen 12; (ii) a detection module configured to analyze the captured visual sensor data; (iii) a screen capture mechanism, such as a PrintScreen script 64, installed on the computer terminal 52A; and (iv) a server 54 configured to store evidence of detected events in a database 60.

The detection module is configured to detect photographing activity directed toward the screen 12 based on at least one of: (a) identification of a camera device 14; (b) identification of a photographing posture of a user 50A; (c) identification of visual characteristics of an optical imaging component; or (d) behavioral patterns consistent with photographing activity.

Upon detection of photographing activity, the system automatically executes the screen capture mechanism to capture the content 58A displayed on the screen 12 at the time of the event. The captured content 58A may be transmitted to server 54 and stored in database 60.

In some embodiments, the system additionally captures an image of the individual 50A performing the photographing activity, thereby producing an evidence package containing (i) the screen content that was potentially exfiltrated and (ii) identity evidence of the actor.

In some embodiments, the stored evidence record further includes event metadata, such as a timestamp 76, a computer terminal identifier (e.g., 52A), confidence scores, detection indicators, and/or other data useful for investigation.

The invention therefore provides a visual, behavior-based insider threat detection capability that can be deployed using standard hardware components (e.g., built-in webcams) and that produces a structured forensic record for investigation and enforcement.

Screen Protection Architecture. In some embodiments, the system further includes a screen protection architecture configured to actively interfere with photographic capture of information displayed on the screen 12. The protection architecture may dynamically modify visual output of the display in response to detected or suspected photographing activity in order to prevent or degrade the ability of external imaging devices to capture readable images of the displayed information. Such modification may include, for example, dynamic pixel modulation, screen blurring, brightness interference, temporal flicker patterns, pixel shifting, watermark rendering, scrambling of displayed regions, masking of sensitive content, or other display transformation techniques.

### BRIEF DESCRIPTION OF THE DRAWINGS

Embodiments, features, and aspects of the invention are described herein in conjunction with the following drawings:

FIG. 1 depicts the problem to be solved, in which a person 50A attempts to photograph screen 12 of computer terminal 52A using a camera device 14.

FIG. 2 depicts photographing security system 10 according to one embodiment of the invention, including sensor 20, server 54, database 60, and a screen capture mechanism such as PrintScreen script 64.

FIG. 3 depicts database 60 storing captured screen content 58A and associated event metadata including timestamp 76.

FIG. 4 depicts an investigation scenario in which a security officer 50C reviews stored evidence records and presents evidence to a suspected user.

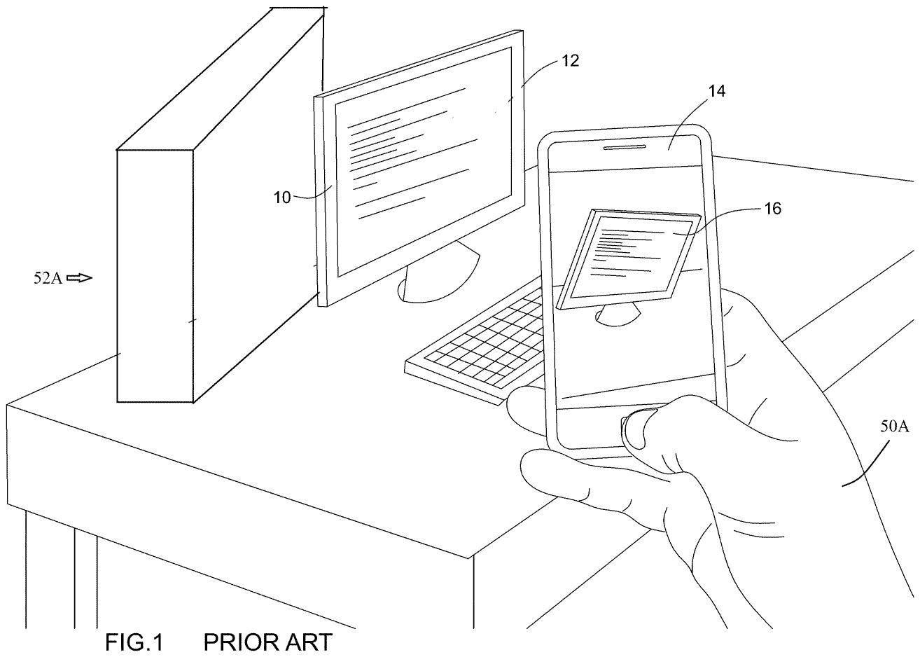

The drawings are not necessarily drawn to scale. Similar reference numerals may designate similar components throughout the drawings.

### DETAILED DESCRIPTION OF THE INVENTION

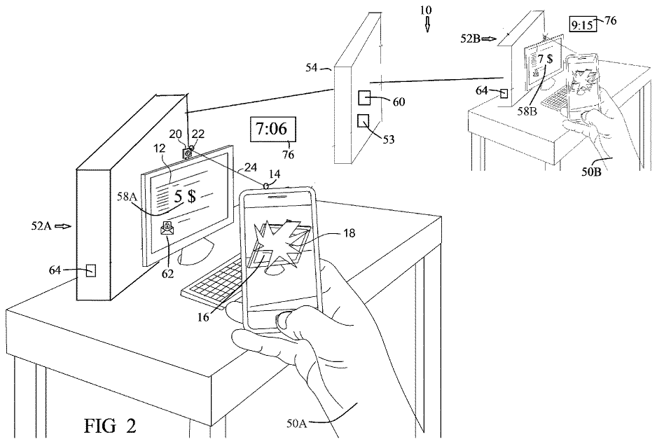

Reference is now made to the drawings. FIG. 2 depicts photographing security system 10 according to one embodiment of the invention. System 10 is associated with one or more computer terminals, such as computer terminal 52A having screen 12.

Sensor 20 is associated with computer terminal 52A. In one embodiment, sensor 20 comprises a built-in laptop camera. In other embodiments, sensor 20 comprises an external webcam or a dedicated monitoring camera positioned near screen 12. In still other embodiments, sensor 20 may include additional sensors capable of capturing visual sensor data representing the environment in front of screen 12, such as depth sensors or multi-spectral cameras, while still being considered a sensor capturing visual sensor data.

Sensor 20 captures visual sensor data of the area in front of screen 12. The captured visual sensor data may include still images and/or video frames. The captured visual sensor data is analyzed by the detection module. The detection module may execute locally on computer terminal 52A, on server 54, or in a distributed manner between the terminal and server.

In one embodiment, photographing activity is detected, for example, by identifying a camera device 14 within the captured visual sensor data. Identification may be performed using visual object recognition and may consider the shape, outline, appearance, and/or characteristic features of a smartphone or camera.

In one embodiment, photographing activity is detected by identifying a photographing posture of a user 50A. The photographing posture may include holding a device at a characteristic height and orientation, directing the device toward screen 12, and maintaining a posture consistent with capturing an image.

In one embodiment, photographing activity is detected by identifying visual characteristics of an optical imaging component. Such characteristics may include lens geometry and/or reflective properties observed in the captured visual sensor data.

In one embodiment, photographing activity is detected by behavioral pattern analysis, such as a combination of device detection and posture detection, optionally with temporal consistency over multiple frames to reduce false positives.

In some embodiments, the detection module may implement machine learning models, computer vision algorithms, heuristic analysis, or combinations thereof for analyzing the captured visual sensor data and detecting photographing activity.

Such machine learning models may include classification models, neural network architectures, deep learning models, behavioral inference models, or other artificial intelligence techniques configured to identify imaging devices, photographing posture, optical components, or behavioral patterns associated with photographing activity.

In some embodiments, the detection module may continuously improve detection accuracy through training, model updates, or adaptive learning based on previously detected photographing events. Such adaptive mechanisms may utilize historical event data, feedback from security investigations, or model retraining processes in order to improve detection reliability over time.

In some embodiments, the system may initiate the security response based on a probability or risk assessment indicating a likelihood of photographing activity, even when a specific imaging device is not positively identified.

Upon detecting photographing activity, the system triggers a security event. In response to the security event, a screen capture mechanism, such as PrintScreen script 64, is executed on computer terminal 52A to capture the content 58A displayed on screen 12 at substantially the same time the photographing activity is detected.

Camera-Agnostic Prevention. In some embodiments, the protection mechanisms may be triggered regardless of the specific camera device type detected. The system may initiate protective display modifications based on behavioral analysis, contextual indicators, or suspected photographing activity even when a specific camera device cannot be positively identified. This allows the system to prevent or degrade photographic capture by a wide range of devices including smartphones, wearable cameras, smart glasses, miniature cameras, IoT cameras, remote cameras, or future image capture devices not yet known.

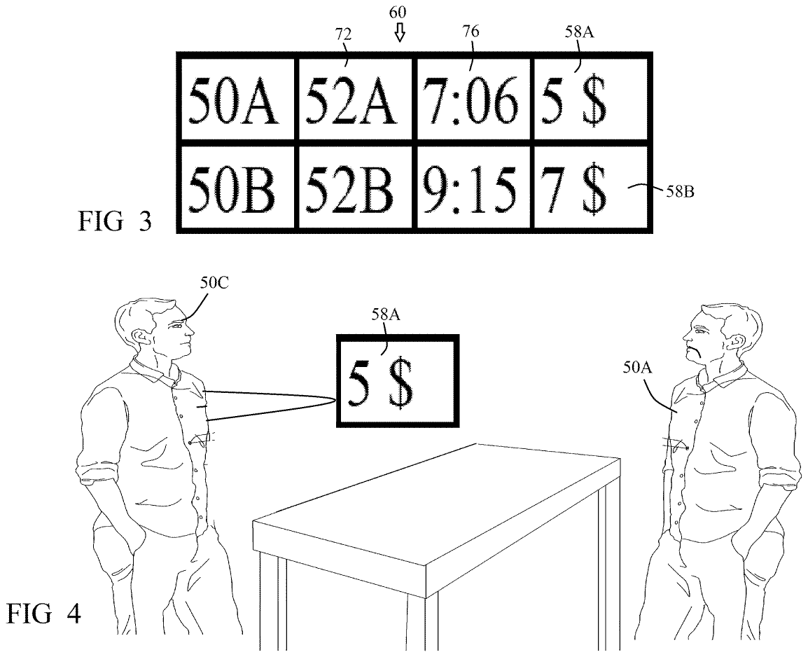

Captured content 58A may be stored locally and/or transmitted to server 54. Server 54 stores the captured content 58A in database 60. FIG. 3 depicts an example arrangement of database 60 that stores captured content and event metadata.

In some embodiments, the system captures an image of the individual 50A performing the photographing activity. The captured image may be derived from sensor 20 at the time of detection and stored with the associated captured content 58A.

In some embodiments, the system includes an identity attribution component configured to associate the evidence record with a user identity. In one embodiment, a facial recognition module identifies the individual 50A. In another embodiment, identity attribution may be based on enterprise login identity associated with computer terminal 52A, optionally combined with captured face imagery for corroboration.

The evidence record stored in database 60 may include, by way of example: (i) captured screen content 58A; (ii) captured image of the actor; (iii) timestamp 76; (iv) computer terminal identifier (52A); (v) detection indicators (e.g., device detected, posture detected, lens characteristics detected); and (vi) a confidence score or risk level.

FIG. 4 depicts an investigation scenario. A security officer 50C may review evidence records in database 60. In one embodiment, the officer 50C may retrieve the relevant record, view captured screen content 58A and associated actor imagery, and initiate an investigation or enforcement action based on organizational policy.

In one embodiment, the system generates an alert to security personnel upon detection, including a link to the relevant evidence record. In one embodiment, the system may support a workflow in which the stored evidence is presented during an interview or hearing, as depicted in FIG. 4.

It will be appreciated that variations, modifications, and combinations of the embodiments described herein may be made without departing from the scope of the invention as defined by the claims.

### TECHNICAL DISTINCTION OF THE PROPOSED SYSTEM

The present invention addresses the problem of unauthorized photographing of sensitive information displayed on computer screens. While various security approaches exist in the field, the proposed system introduces several technical distinctions that significantly differ from conventional solutions.
1. Visual Behavioral Detection Instead of Sensor Detection. Existing solutions often rely on external sensors or environmental signal detection to determine whether a photographing device is present. In contrast, the present invention utilizes computer vision analysis, behavioral posture recognition, and visual object identification based on visual sensor data captured by sensor 20.
2. Detection of Human Photographing Behavior. Traditional systems focus primarily on detecting devices. The present invention focuses on detecting human behavior associated with photographing activity, including the physical posture associated with taking a photograph and the orientation of a handheld device relative to the screen.
3. Computer Vision Identification of Camera Devices and Photographing Behavior. The invention uses visual object recognition to identify camera devices and photographing behavior associated with image capture activities. This differs from approaches that rely on infrared reflection, electromagnetic signals, or optical lens detection sensors.
4. Identity Attribution of the Actor. A further technical distinction of the present invention is the ability to identify the individual attempting to photograph the display. This may be achieved through facial recognition analysis and/or visual identification of the individual in front of the screen.
5. Automated Forensic Evidence Capture. Upon detection of photographing activity, the system automatically captures the content displayed on the screen and the image of the individual performing the action. The captured information is stored together with event metadata such as timestamp 76, user identity, and device detection indicators, creating a forensic evidence record.
6. Combined Detection Architecture. The invention combines object recognition (camera device detection), behavioral analysis (photographing posture detection), and biometric identification (face recognition), improving reliability compared to single-sensor systems.
7. Independence from Specialized Hardware Sensors. The invention operates using standard hardware components such as built-in webcams, without requiring specialized infrared sensors, dedicated hardware detectors, or external sensor arrays.
8. Insider Threat Detection Capability. The invention is particularly suited for detecting insider threats where an authorized user attempts to capture sensitive information displayed on a screen using a personal camera device.
9. Visual Evidence-Based Security. Unlike systems that merely generate alerts, the present invention produces visual evidence of the attempted activity, including both the captured screen content and the image of the actor, enabling effective investigations and policy enforcement.

### REFERENCE SIGNS LIST

10 photographing security system
12 screen
14 camera device/image capture device
20 sensor (camera) associated with the computer terminal
50A person/user
50C security officer
52A computer terminal
54 server
58A captured screen content
60 database
64 PrintScreen script
70 screen protection module
76 event timestamp

1. A computer security method for protecting information displayed on a computer terminal (52A), the method comprising:
capturing by at least one sensor (20) associated with the computer terminal;
sensor data representing an environment located in front or around a screen (12) of the computer terminal, the sensor data comprising at least visual sensor data ;
analyzing, by a detection module, at least a portion of the captured sensor data;
detecting photographing activity directly or indirectly associated with the screen based on at least one of: identification of an imaging device, identification of a photographing posture of a user (50A), identification of visual characteristics of an optical imaging component, detection of optical reflection indicative of an optical imaging component, or behavioral analysis indicating photographing activity; and
upon detecting said photographing activity, performing a security response affecting information displayed on the screen, the security response comprising at least one protective action selected from:
capturing content displayed on the screen,
capturing visual evidence associated with the photographing activity, or modifying screen output to reduce an ability of the imaging device to capture readable information.

2. The method according to claim 1, wherein the security response comprises capturing content displayed on the screen.

3. The method according to claim 1, wherein the security response comprises capturing visual evidence associated with an individual performing the photographing activity.

4. The method according to claim 3, wherein capturing visual evidence comprises capturing an image of the individual located in front of the screen.

5. The method according to claim 2, further comprising storing captured screen content in a database.

6. The method according to claim 3, further comprising storing captured visual evidence in a database.

7. The method according to claim 5 or claim 6, wherein stored information further includes at least one of a timestamp, an identifier of the computer terminal, or an identity of a user associated with the computer terminal.

8. The method according to claim 1, wherein the security response comprises performing a screen protection action configured to reduce readability of information displayed on the screen.

9. The method according to claim 8, wherein the screen protection action comprises at least one of screen blurring, pixel scrambling, brightness modulation, display flickering, dynamic pixel shifting, watermark insertion, or temporary masking of displayed content, thereby reducing the ability of an imaging device to capture readable information from the screen.

10. The method according to claim 1, wherein detecting photographing activity and performing the security response are activated only when the system determines that the screen displays classified or sensitive information.

11. A computer security system (10) for detecting unauthorized photographing of information displayed on a computer terminal (52A), the system comprising:
at least one sensor configured to capture sensor data from an environment located in front of or around a screen of the computer terminal;
a detection module configured to analyze the captured sensor data in order to detect photographing activity directly or indirectly associated with the screen of the computer terminal; and
a security response module configured to perform a security response upon detection of the photographing activity, the security response affecting information displayed on the screen of the computer terminal.

12. The system according to claim 11, wherein the detection module identifies imaging devices using visual object recognition techniques.

13. The system according to claim 11, wherein the detection module identifies a photographing posture of a user based on body orientation, hand positioning, and device alignment relative to the screen.

14. The system according to claim 11, further comprising a facial recognition module configured to identify an individual performing the photographing activity.

15. The system according to claim 11, wherein the security response module performs at least one action selected from capturing screen content, recording visual evidence, storing forensic records, or modifying screen output to prevent readable image capture.
